(19) United States
(12) Patent Application Publication
(10) Pub. No.: US 2007/0056667 A1
(43) Pub. Date: Mar. 15, 2007

(54) Wheel for a Floor Surface

(75) Inventor: Peter Worwag, Staad (CH)

Correspondence Address: GUDRUN E. HUCKETT DRAUDT, LONSSTR. 53, WUPPERTAL, 42289, DE

(73) Assignee: DUPRO AG, Romanshorn (CH)

(21) Appl. No.: 11/470,693

(22) Filed: Sep. 7, 2006

(30) Foreign Application Priority Data
Sep. 13, 2005 (DE) 10 2005 043 848.2

(51) Int. Cl. B60C 11/00

(52) U.S. Cl. 152/212; 152/168

(57) ABSTRACT

A wheel for an object to be moved on a floor surface has a hub and an outer running surface secured to the hub. The running surface is rotatable about an axis of rotation. A fiber layer of fibers is applied onto the running surface. The fiber layer forms an intermediate layer between a floor surface and the running surface when the wheel moves across the floor surface. The fiber layer is a flocking applied to the running surface.

### BACKGROUND OF THE INVENTION

The present invention relates to a running wheel for an object, in particular, a vacuum cleaning device, a vacuum cleaning tool or the like, to be moved on a floor surface, wherein the running wheel has an outer running surface and a hub, wherein the running surface is supported on the object so as to be rotatable about an axis of rotation.

Running wheels are known in general. Pieces of furniture as well as shelves, chairs, armchairs, tables or the like as well as tools such as vacuum cleaners or other vacuum cleaning devices, vacuum cleaning tools, floor nozzles or the like have running wheels with which the objects can be moved on a floor surface.

When floor nozzles are provided with running wheels for cleaning hard floor surfaces such as parquet, linoleum floors, tiled floors or marble floors, the running wheels generated on the hard floor surfaces significant noise, in particular when crossing joints. It can also happen that dirt particles that are present between the running wheels and the floor or improper use of the vacuum cleaning tool will cause damage to the floor surface. The operator therefore is required to be particularly careful when using the vacuum cleaning tools, especially in the case of sensitive hard floor surfaces.

### SUMMARY OF THE INVENTION

It is an object of the present intention to design running wheels for objects to be moved on hard floor surfaces in such a way that damage to the floors is substantially prevented.

This object is solved in accordance with the present invention in that a fiber layer is attached to the running surface and forms an intermediate layer between the floor surface and the running surface.

By arranging a fiber layer between the floor surface and the running surface, an intermediate layer is effectively provided that reduces not only the rolling noise but also prevents damage to the floor surface to be cleaned. Vacuum cleaning tools such as floor nozzles or the like can therefore be guided across hard and smooth floor coverings in a noise-reduced and gentle way.

It has been found to be expedient to form the fiber layer by flocking the running surface. Flocking is the application of fine particles such as fibers on a surface that has been made adhesive.

In one embodiment of the invention, the flocking is comprised of short fibers that are secured essentially with one of their ends in an adhesive layer that has been applied to the running surface. The fibers have a length of approximately 0.3 mm to 3 mm, preferably of 0.5 mm to 2 mm; they have, depending on their length, a thickness of approximately 0.5 decitex to 7 decitex, preferably approximately 1 decitex to 6 decitex. As materials, fibers made from viscose, cotton, rayon, polyamide, polyester and/or acrylic fibers have been found to be expedient; in particular, polyamide such as nylon or Perlon® are advantageous.

According to the invention, the running surface of the running wheel is formed by an approximately cylindrical running ring wherein the running ring is a separate component mounted on a carrier. The carrier is connected to the hub; expediently, the carrier itself provides the hub of the running wheel.

The hub is comprised of two hub halves between which the running ring is secured, preferably fixedly (non-rotatably). The hub halves of the assembled hub engage one another by means of a mounting projection and are locked positively with one another by means of locking tongues in the mounted position. The hub halves are configured as identical parts; this is advantageous in regard to manufacture as well as assembly. It can be expedient in this connection to produce the hub halves from a first plastic material and the running ring from a second plastic material having different properties or from a metallic material.

When producing a running ring as a separate component, it is possible to apply a fiber layer onto a cylinder having any length, for example, by flocking or by gluing, winding, welding or fusing or similar means of attachment. After application of the fiber layer onto the cylindrical base member, a running ring of the desired width is separated from it, for example, by cutting, trimming, cropping, or the like. The running ring manufactured in this way is pushed onto the wheel rim of the first hub half and, subsequently, the second hub half is pushed on. The wheel rim section of the second hub half also engages the running ring so that the running ring is securely held on the wheel rim between the beads of the wheel rim. Advantageously, the running ring is secured fixedly on the hub halves for which purpose gluing, welding or fusing to the hub but also a positive locking engagement within the hub is expedient.

In another constructive embodiment of the invention, the running surface and the hub constitute together a monolithic component that is preferably comprised of plastic material and represents the running wheel. The running surface is expediently configured as an approximately cylindrical circumferential surface; it can be advantageous to design the circumferential surface to be slightly spherical. In particular, the hub and the running surface can adjoin one another by a curved portion that is of a spherical or dome shape.

In particular, the flocking extends across the circumferential rim of the running surface so that also across the edges of the running surface a fiber layer is present; this, on the one hand, contributes to a gentle rolling action and to noise damping and, on the other hand, provides an impact protection for furniture, walls, strips or moldings and the like. Protective strips that are made from rubber or plastic material and are provided on floor nozzles lead to streaks on light-colored surfaces; streaking or scratching can be safely prevented in accordance with the present invention by not only flocking the running wheels but also the outer housing surfaces.

The fiber layer of the flocked material extends in one embodiment up to the spherical or dome-like curved portion between the hub and the running surface but can also extend to the center of the hub in order to provide a protective action in the case of axial impact.

The running wheel according to the invention is comprised expediently of plastic material, metal or other suitable materials.

### BRIEF DESCRIPTION OF THE DRAWINGS

FIG. 1 is a schematic view of the vacuum cleaning tool to be connected to a vacuum cleaning device such as a vacuum cleaner or the like.

FIG. 2 shows a bottom view of the vacuum cleaning tool according to FIG. 1.

FIG. 3 shows a running wheel according to the invention for an object to be moved across a floor surface.

FIG. 4 is a schematic illustration of a section of a flocked running surface of a running wheel.

FIG. 5 shows a running wheel according to the invention in another configuration.

FIG. 6 shows a section along the section line VI-VI of FIG. 5.

FIG. 7 is an exploded view of the running wheel according to FIG. 5.

FIG. 8 is an end view of a base member for producing the running ring.

FIG. 9 shows a section of a ring having the desired width.

### DESCRIPTION OF PREFERRED EMBODIMENTS

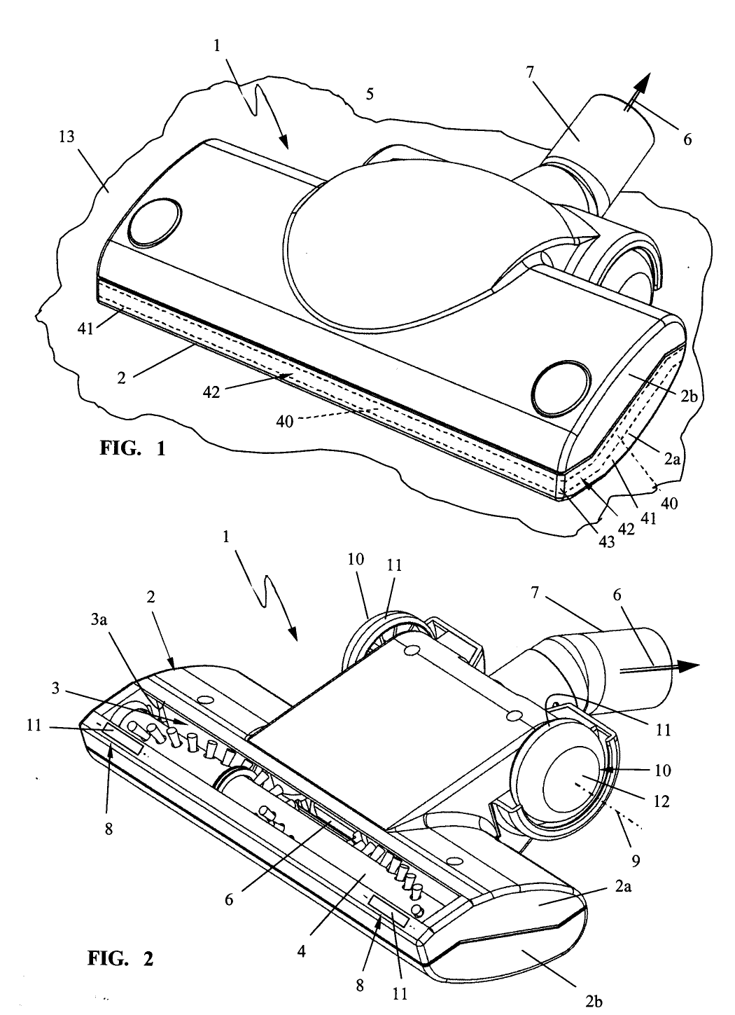

The vacuum cleaning tool 1 illustrated in FIGS. 1 and 2 is comprised essentially of a housing 2 comprised of a bottom part 2a and top part 2b. A brush chamber 3 is formed in the housing 2; a brush roller 4 extending across the width of the vacuum cleaning tool is rotatably supported in the brush chamber 3. The brush roller 4 is driven by an air turbine, not illustrated in detail; the air turbine is arranged in a turbine chamber 5 through which the vacuum air flow 6 passes. For connecting the vacuum cleaning tool to a vacuum cleaning device, the housing 2 is provided with a connecting socket 7.

The vacuum cleaning tool 1 is placed onto a floor surface 13 to be cleaned and is supported on the floor surface 13 by means of the running wheels 8, 10. In the illustrated embodiment of the vacuum cleaning tool according to FIG. 1 and FIG. 2, in the rear area of the housing 2 there are two running wheels 10 that are rotatably supported about axis of rotation 9 in the housing 2 of the vacuum cleaning device 1. It can be advantageous to provide also the front area of the vacuum cleaning tool 1 with running wheels 8 that can be of a different size. Such running wheels 8, if embodied as rollers, can be provided at the leading edge of the vacuum slot 3a of the vacuum cleaning tool.

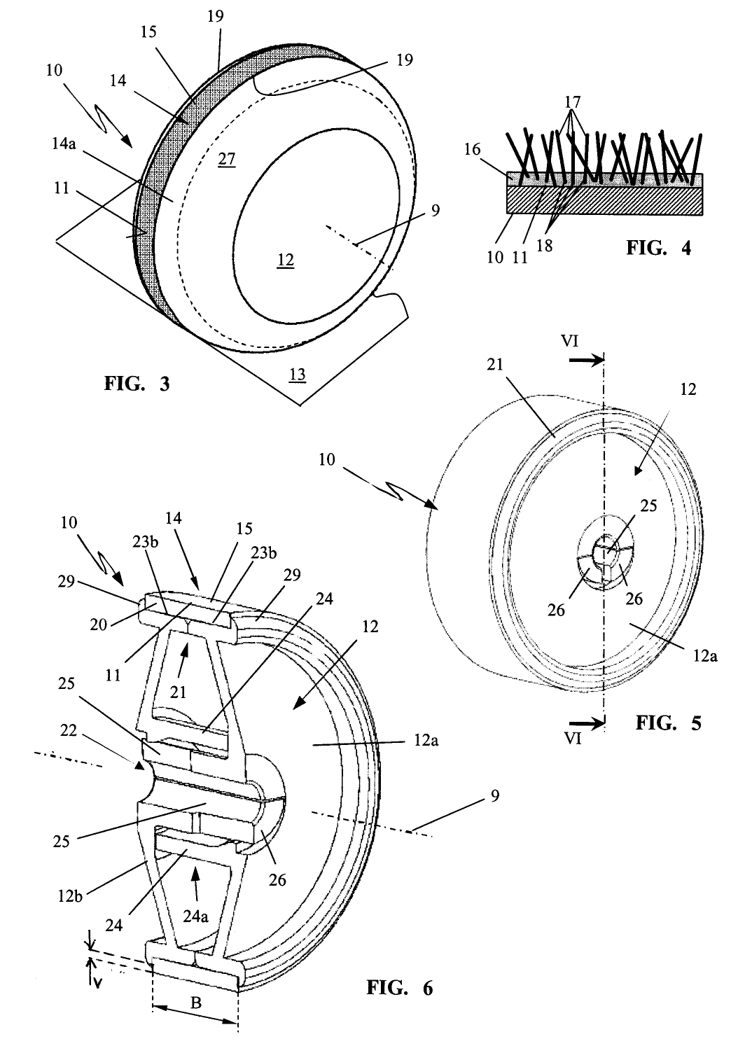

As shown in FIG. 3, each running wheel 8, 10 has an outer running surface 11 that forms together with the hub 12 the base element of a running wheel 10. By means of the hub 12, the running wheel 10 is secured on the housing 2 of the vacuum cleaning tool 1, preferably so as to be rotatable, wherein the running surface 11 rotates about axis of rotation 9. Expediency, the running surface 11 together with the hub 12 rotates about axis of rotation 9. It can also be advantageous to fixedly mount the hub 12 on the housing 2 and to allow the running surface 11 to rotate about the hub 12 about axis of rotation 9.

For protecting the floor surface 13 across which the vacuum cleaning tool 1 is guided, the running surface 11 has a fiber layer 15 that forms an intermediate layer between the floor surface 13 and the running surface 11 when rolling on the floor surface 13. In the illustrated embodiment, fiber layer 15 is formed by flocked material (flocking) 14 that can be applied directly onto the running surface 11.

As can be seen in the enlarged schematic illustration of FIG. 4, a layer 16 of a glue or an adhesive is applied to the running surface 11 of the running wheel 10; the glue or adhesive fixedly adheres to the running surface 11 of the running wheel 10. Short fibers 17 are secured within the adhesive layer 16 and have a length of approximately 0.3 mm to 3 mm, preferably 0.5 mm to 2 mm. The short fibers 17 are substantially secured with one end 18 in the adhesive layer 16, respectively, and are therefore fixedly connected to the running surface 11 of the running wheel 10. Technically, this is advantageously done by electrostatic application wherein the electrostatic forces are used to shoot the ends 18 of the fibers 17 deep into the adhesive layer 16 so that each individual fiber 17 is captively secured in a substantially upright position within the adhesive layer 16.

The fiber thickness is preferably between 0.5 decitex to 7 decitex, in particular between 1 decitex to 6 decitex, depending on the selected length of the fibers 17. Decitex is an international unit of measure for textile fibers and is defined as the weight (mass) in g per 10,000 meters of a running length of the fiber. One tex corresponds to 1 gram per 1 kilometer. The higher the decitex number, the coarser the fiber. For example, cotton has fibers of 1.5 decitex to 2.5 decitex.

Viscose, cotton, rayon, polyamide, polyester and/or acrylic fibers have been found to be advantageous as a suitable material for use as a fiber layer that is produced, for example, by flocking on the running wheel. In particular, materials from the group of polyamides, in particular nylon or Perlon®, have been found to be expedient.

In order to ensure gentle rolling or gliding across a hard floor surface 13, it is expedient when the flocking or flocked material 14 extends past the lateral circumferential rim 19 of a running surface 11 (flocking 14a). In the embodiment of FIG. 3, the flocking 14, 14a extends into a spherically curved portion 27 by which the running surface 11 and the hub 12 adjoin one another. When the flocking 14, 14a extends into the axial end face of the hub 12, furniture, walls, strips or the like furnishings can be protected from becoming damaged. Moreover, the noise produced when impacting is significantly reduced; this is advantageous in particular when vacuuming tiled floors.

As illustrated in FIG. 1, in addition to the flocked material 14 on the running wheels or in place of the flocking on the running wheels 10, it can also be expedient to provide the outer housing parts 41 of the vacuum cleaning tool 1 with flocked material 42 in order to provide a protection against damage to furnishings. Advantageously, on selected external lateral surfaces of the housing 2, strips 40 (FIG. 1) that extend expediently circumferentially are directly generated by flocking or flocked protective strips made from a flocked textile material or another flexible or hard material are permanently attached. As a result of the circumferential arrangement, housing corners 43 are also covered.

As illustrated in FIG. 3, the running surface 11 and the hub 12, advantageously together with the curved portion 21, can be produced as a monolithic component that is comprised in particular of plastic material.

The running wheel 10 itself or the base element of the running wheel 10 can be made from plastic material, metal or other materials. A fiber layer, for example, in the form of flocked material 14, can be applied permanently on many materials. Depending on the material of the base element of the running wheel 10 a suitable adhesive for the adhesive layer 16 must be selected. In the illustrated embodiment, the running wheel is comprised of plastic material; the adhesive of adhesive layer 16 can partially dissolve the running surface 11 in order to ensure an intimate connection of the adhesive layer 16 and the running surface 11 of plastic material.

In the embodiment according to FIG. 5 to FIG. 9, the running wheel 10 is comprised advantageously of three individual parts. The running surface 11 is formed on a cylindrical running ring 20 that is secured on a wheel rim 23a, 23b of the carrier 21. The carrier 21 is connected to the hub 12; preferably, the hub 12 constitutes the carrier 21, i.e., carrier and hub are a single (monolithic) part.

The hub 12 itself is comprised in the illustrated embodiment of two hub halves 12a, 12b between which the running ring 20 is secured. In this connection, the running ring 20 can be rotatably arranged on the carrier 21; in the illustrated embodiment, the running ring 20 is fixedly connected to the carrier 21 and the hub 12, for example, by gluing, welding or fusing or by positive locking engagement. The hub 12 has a central receptacle 22 for receiving, for example, an axle stub which determines the axis of rotation 9 of the running wheel 10.

For manufacturing a running wheel 10, basically a carrier 21 for the running ring 20 and a hub part 12a or 12b are sufficient. For example, one hub half 12a can be used that has a wheel rim 23a formed integrally thereon. The running ring 20 is pushed onto the wheel rim 23a and secured thereon, for example, by an adhesive, by fusing or the like attachment means. The open side of the running wheel 10 is mounted so as to face the housing 2 so that towards the exterior the hub half 12a of the running wheel 10 is visible.

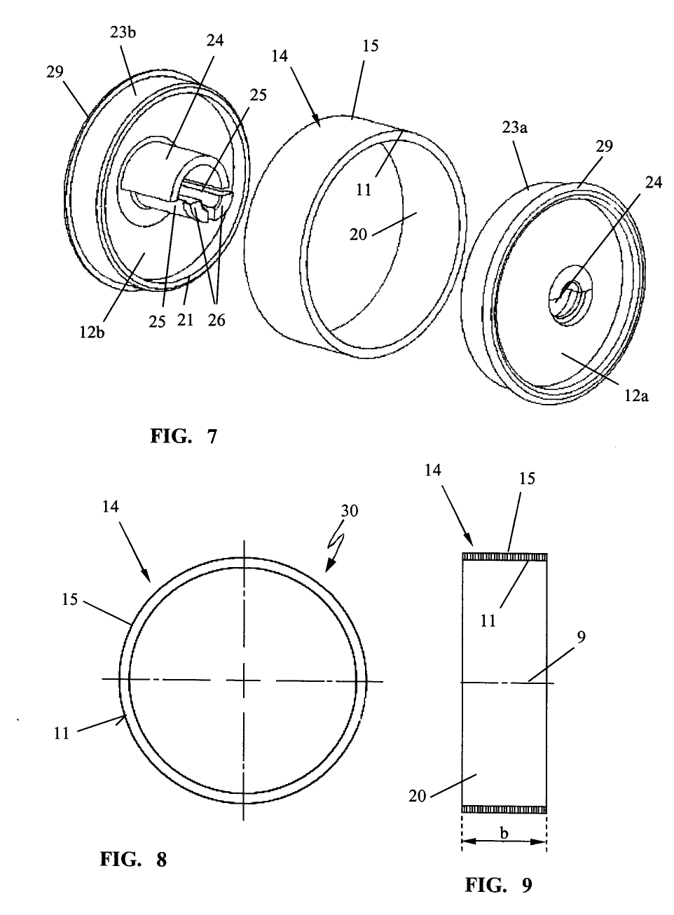

FIG. 7 shows that the hub halves 12a, 12b are identical parts and each hub half 12a, 12b is provided with an outer wheel rim 23a, 23b having a bead 29; when assembled, the halves form the carrier 21 for the running ring 20 (FIG. 6). Each hub half 12a, 12b has a central mounting projection 24 that has the shape of half a cylinder (cut in the axial direction). The two mounting projections 24 serve as axial spacers of the opposed hub halves 12a, 12b and form together an inner cylindrical hub core 24a. Displaced relative to the mounting projections 24, each hub half 12a, 12b has at least one locking tongue 25 with a locking nose 26 at the leading free end. In the illustrated embodiment, two locking tongues 25 are provided that have a part-circular shape and extend, arranged adjacent to one another, about a circumferential angle of 180 degrees. The locking tongues 25 of the hub halves 12a, 12b engage the locking opening of the complementary hub half, respectively, so that both hub halves 12a, 12b are locked by them positively. An axle stub inserted into the central receptacle 22 prevents recoiling of the locking tongues 25 so that the assembled hub 12 is secured in its locked position.

The running ring 20 of the running wheel 10 that is advantageously produced as a component separate from the running wheel 10 is separated as a partial ring from a cylindrical base member 30 (FIG. 8), for example, by cutting, trimming, cropping etc. Before separating a ring having the desired width b, a cylindrical base member of plastic material, cardboard, metal or other suitable material, for example, also elastic material, is provided with a fiber layer 15. This can be realized, for example, by winding an appropriately selected fiber web, such as a nonwoven or the like, onto the base member 30 wherein the corresponding textile web, depending on the selected fiber type of the aforementioned materials, is glued onto the outer surface of the base member 30, fused thereto or intimately connected in any other way to the base member. Preferably, the base member is directly provided with a flocking; this is simple as a result of the cylindrical shape and can be realized without greater machine-technological expenditure to produce piece goods. It is also possible to employ a flocked textile material that is permanently applied to the base member.

The cut-off width b of the running ring 20 is selected such that a minimal oversize relative to the width B is provided that is determined by the wheel rim beads 29 of the carrier 21. When assembling the hub 12, the wheel rims 23a, 23b engage approximately fittingly the running ring 20 so that the running ring 20 is aligned relative to the axis of rotation 9 (FIG. 6). The running ring 20 is clamped axially between the beads 29 as soon as the locking tongues 25 lock in place. The running ring 20 is captively and substantially fixedly secured; it projects radially by the amount v past the wheel bead 29.

The ring 20 can be additionally glued and/or fused or welded to the wheel rim 23a, 23b.

The instant application incorporates by reference the entire disclosure of German priority application 10 2005 043 848.2 having a filing date of Sep. 13, 2005.

While specific embodiments of the invention have been shown and described in detail to illustrate the inventive principles, it will be understood that the invention may be embodied otherwise without departing from such principles.

What is claimed in:

1. A wheel for an object to be moved on a floor surface, the wheel comprising:
a hub;
an outer running surface secured to the hub, wherein the running surface is rotatable about an axis of rotation;
a fiber layer comprised of fibers and applied onto the running surface;
wherein the fiber layer forms an intermediate layer between a floor surface and the running surface when the wheel moves across a floor surface.

2. The wheel according to claim 1, wherein the fiber layer is a flocking provided on the running surface.

3. The wheel according to claim 2, wherein the fiber layer is comprised of an adhesive layer applied to the running surface and wherein the fibers are short fibers having a first end and a second end, respectively, wherein the first ends are secured in the adhesive layer applied onto the running surface to form the flocking.

4. The wheel according to claim 1, wherein the fibers have a length of approximately 0.3 mm to 3 mm.

5. The wheel according to claim 1, wherein the fibers have a length of 0.5 mm to 2 mm.

6. The wheel according to claim 1, wherein the fibers have a thickness of approximately 0.5 decitex to 7 decitex.

7. The wheel according to claim 1, wherein the fibers have a thickness of approximately 1 decitex to 6 decitex.

8. The wheel according to claim 1, wherein the fibers are comprised of at least one of a fiber material selected from the group consisting of viscose, cotton, rayon, polyamide, polyester, and acrylic.

9. The wheel according to claim 1, wherein the fibers are comprised of polyamide.

10. The wheel according to claim 1, wherein the fibers are comprised of nylon.

11. The wheel according to claim 1, further comprising a separate substantially cylindrical running ring having a circumferential surface that forms the to the carrier and the carrier is connected to the hub.

12. The wheel according to claim 11, wherein the carrier and the hub are a monolithic part.

13. The wheel according to claim 11, wherein the hub is comprised of two hub halves, wherein the running ring is secured between the two hub halves.

14. The wheel according to claim 13, wherein the running ring is fixedly attached to the two hub halves.

15. The wheel according to claim 13, wherein the two hub halves each have a mounting projection with a locking tongue, wherein in an assembled position the mounting projections of the two hub halves engage one another and the two hub halves are locked positively relative to one another by the locking tongues.

16. The wheel according to claim 13, wherein the two hub halves are identical.

17. The wheel according to claim 11, wherein the running ring is a partial ring that is cut from a cylindrical base member, wherein the base member supports the fiber layer.

18. The wheel according to claim 17, wherein the fiber layer is intimately connected to the cylindrical base member.

19. The wheel according to claim 18, wherein the fiber layer is glued or fused to the cylindrical base member.

20. The wheel according to claim 1, wherein the running surface and the hub are a monolithic component.

21. The wheel according to claim 20, wherein the fiber layer projects outwardly past a circumferential edge of the running surface.

22. The wheel according to claim 21, wherein the fiber layer covers approximately completely an outwardly facing visible area of the hub.

23. The wheel according to claim 21, wherein the hub and the running surface adjoin one another by a spherically curved portion and wherein the fiber layer extends from the running surface into the spherically curved portion.
